(19) United States
(12) Patent Application Publication
(10) Pub. No.: US 2020/0385113 A1
(43) Pub. Date: Dec. 10, 2020

(54) AUTONOMOUS FLYING VEHICLE

(71) Applicant: The Goodyear Tire & Rubber Company, Akron, OH (US)

(72) Inventors: Sebastien Willy Fontaine, Vichten (LU); Armand René Gabriel Leconte, Bigonville (LU); Frederic Ngo, Mersch (LU); Gilles Reichling, Vichten (LU); Claude Ernest Felix Boes, Erpeldange-sur-Sûre (LU); Jean-Francois Vandeclee, Bastogne (BE); Daniel Paul Luc Marie Hinque, Habay-la-Neuve (BE); Vincent Jean Emile Decouvreur, Florennes (BE)

(21) Appl. No.: 16/797,683

(22) Filed: Feb. 21, 2020

Related U.S. Application Data
(60) Provisional application No. 62/809,075, filed on Feb. 22, 2019.

(51) Int. Cl. B64C 37/00; B60C 7/18; B60F 5/02; G05D 1/10

(52) U.S. Cl. CPC B64C 37/00; B60C 7/18; B60C 2007/146; G05D 1/101; B60F 5/02

(57) ABSTRACT

A flying machine having a light weight housing is described. Th light weight housing includes a cabin for housing one or more passengers, a flight control system, and at least two nonpneumatic wheels. Each non-pneumatic wheel includes a ground contacting annular tread portion; a plurality of vanes extending between a hub of the non-pneumatic wheel and the annular tread, wherein each vane is formed of a reinforced layer of fabric, wherein each nonpneumatic wheel is mounted on a rotatable support arm, and wherein the wheel is rotated at a high rate of speed to generate lift of the flying machine.

### FIELD OF THE INVENTION

The present invention relates generally to a flying vehicle having vehicle tires used as rotors, and more particularly, to an autonomous flying vehicle with a non-pneumatic wheel which acts as a rotor.

### BACKGROUND OF THE INVENTION

As the challenges of urban transport and congestion continue to grow, mobility companies are searching for new solutions. Increasingly, they are looking to the sky for the answer. The technology behind flying cars is developing at a huge pace and they now seem closer than ever. Specially designed so that they can tilt and become rotors, AERO tires would be the foundation of a new, environmentally-friendly, on-demand, congestion-free mobility solution. The concept's non-pneumatic structure supports the weight of the vehicle for worry-free mobility on road while becoming the fins of the rotor Thus an improved flying machine which utilizes a non-pneumatic wheel as rotor is desired, and that has all the features of the pneumatic tires without the drawback of the need for air inflation is desired.

### Definitions

The following terms are defined as follows for this description.

“Equatorial plane” means a plane perpendicular to the axis of rotation of the tire passing through the centerline of the tire.

“Meridian plane” means a plane parallel to the axis of rotation of the tire and extending radially outward from said axis.

“Hysteresis” means the dynamic loss tangent measured at 10 percent dynamic shear strain and at 25° C.

### DETAILED DESCRIPTION OF THE DRAWINGS

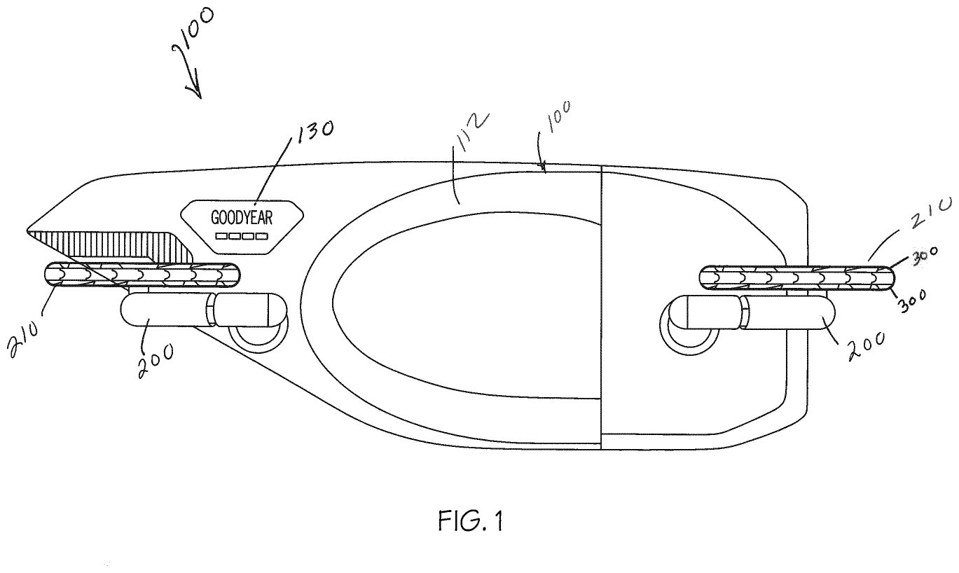

FIG. 1 illustrates a front view of a flying machine of the present invention with the non-pneumatic wheels in a retracted position;

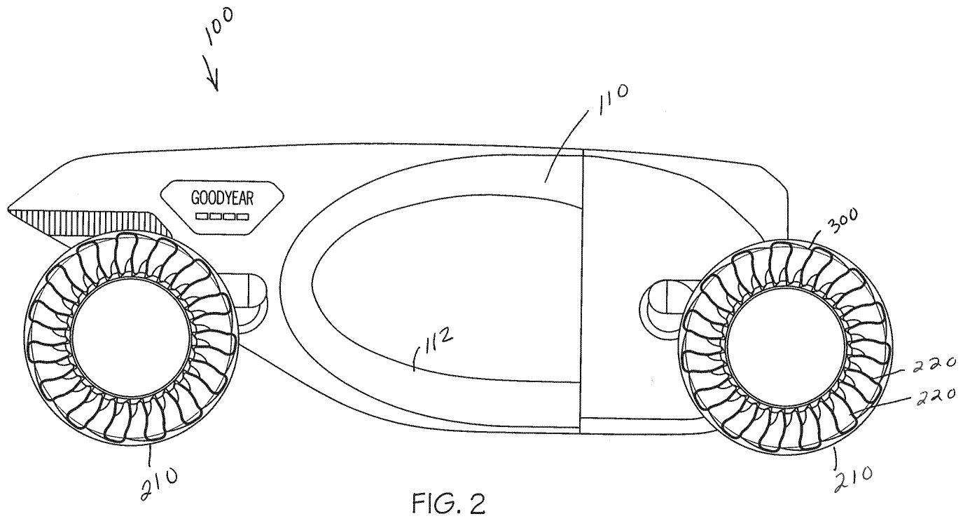

FIG. 2 illustrates a front view of a flying machine of the present invention with the non-pneumatic wheels in a downward position;

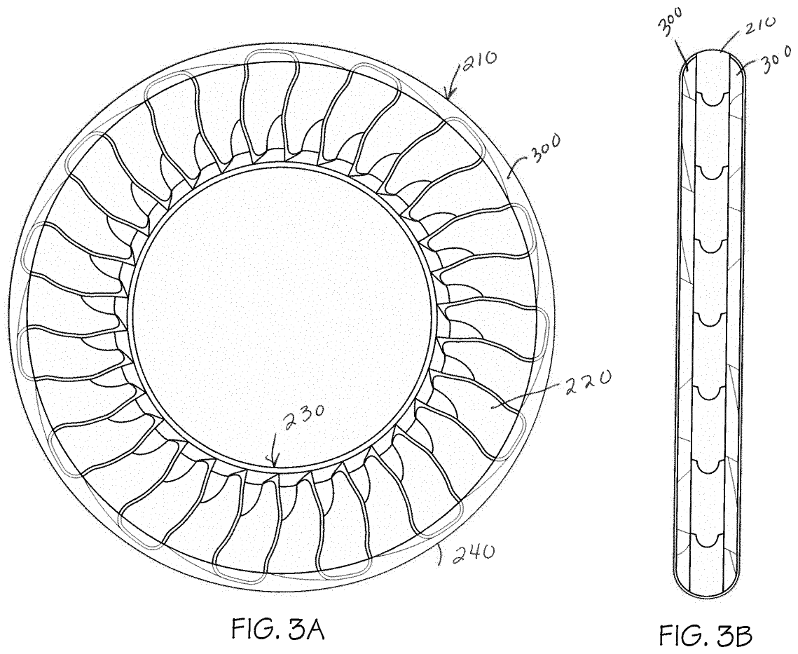

FIG. 3A is a front view of a nonpneumatic wheel of the present invention.

FIG. 3B is a side view of the nonpneumatic wheel of FIG. 3A.

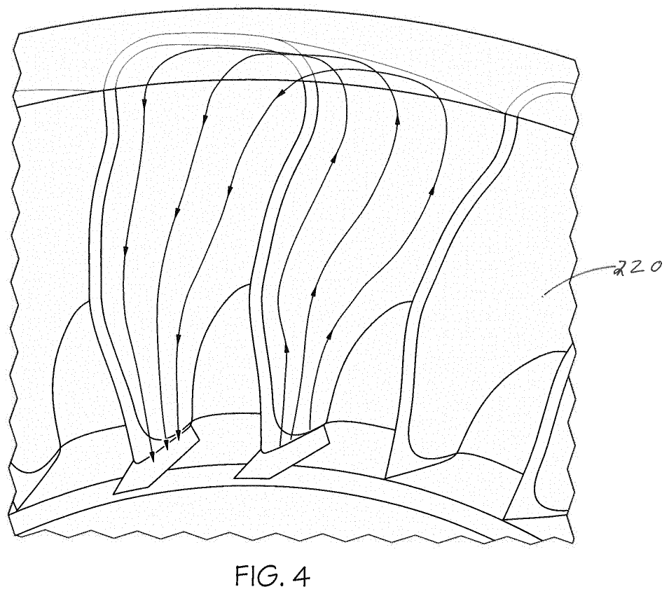

FIG. 4 is a closeup view of the spokes of the nonpneumatic wheel of FIG. 3B.

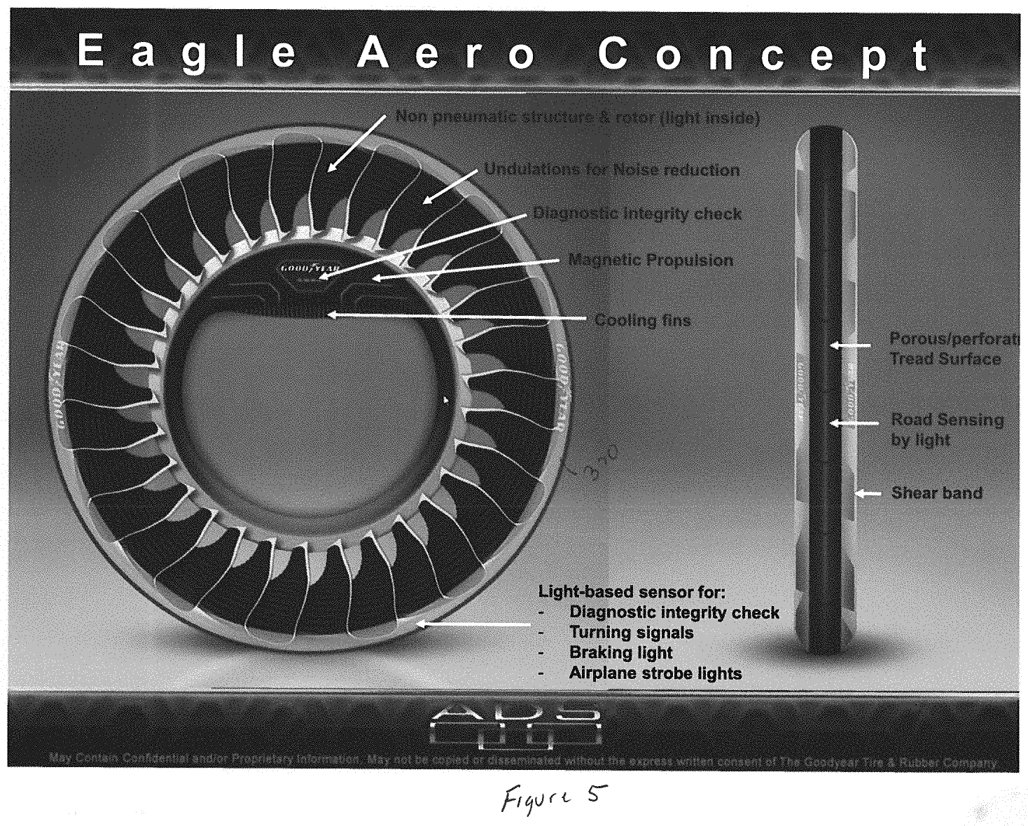

FIG. 5 is a front view of the nonpneumatic wheel illustrating the light sensor.

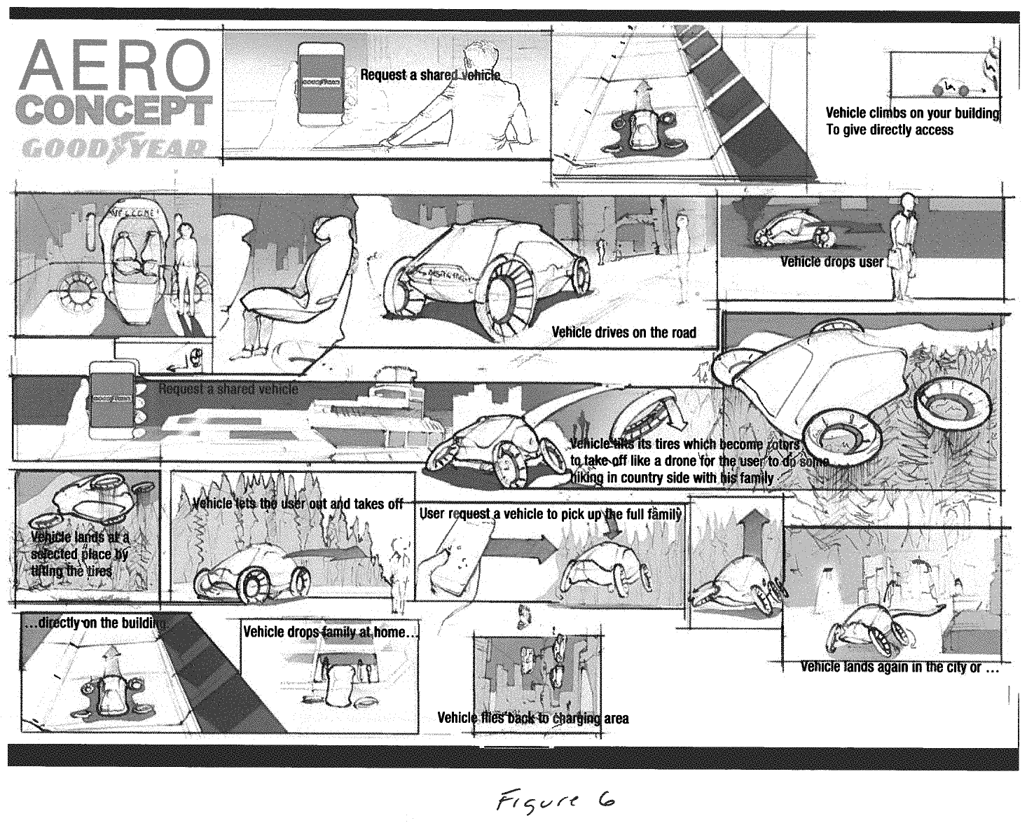

FIG. 6 illustrates the utilization of the flying machine.

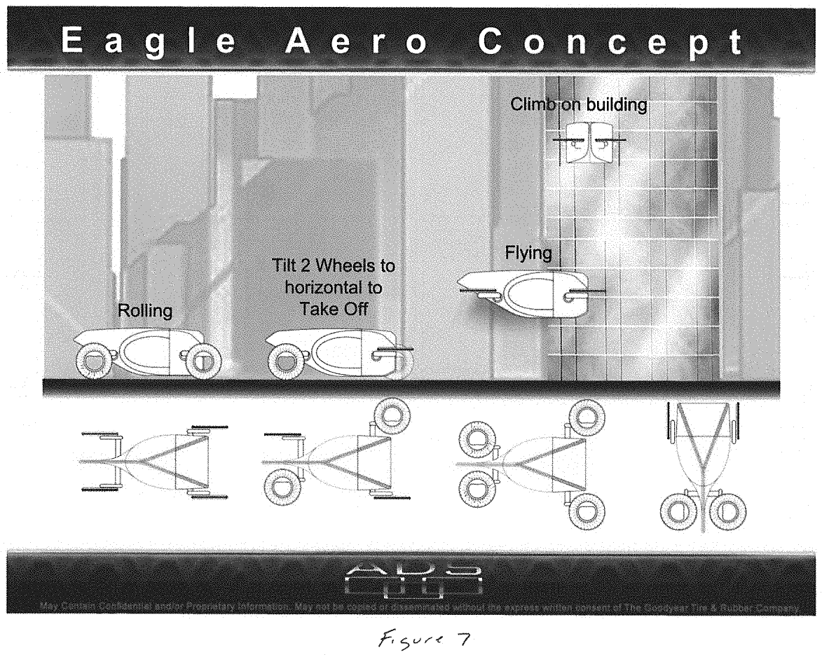

FIG. 7 illustrates the various wheel positions in the driving mode, and flying mode.

### DETAILED DESCRIPTION OF THE INVENTION

An autonomous flying machine 100 of the present invention is shown in the enclosed figures. The autonomous flying machine 100 includes a cabin 110 having a door 112 for housing one or more passengers. The autonomous flying machine 100 includes a flight computer control system 130 which can autonomously fly the aircraft without a pilot. The autonomous flying machine 100 includes at least three non-pneumatic wheels, which function as load bearing wheels allowing the flying machine to be driven on the road when on the ground. The non-pneumatic wheels also function as rotors, and generate a lifting force when rotated, which is sufficient to propel the flying machine off of the ground. The nonpneumatic wheels are mounted on support arms 200, which rotate the nonpneumnatic wheels at a desired angle, typically ninety degrees or more, as shown in FIG. 1. Tilting the wheels ninety degrees and then using an electric motor to rotate the wheels at a high rate of speed generates a lifting force, allowing the flying machine to vertically take off (VTOL).

The nonpneumatic wheel of the present invention includes a radially outer ground engaging tread, a shear band, and one or more reinforcement layers. The non-pneumatic tire of the present invention is designed to be a top loaded structure, so that the shear band and the reinforcement layer efficiently carries the load. The shear band and the reinforcement layer are designed so that the stiffness of the shear band is directly related to the spring rate of the tire. The reinforcement layer is designed to be a stiff structure that buckles or deforms in the tire footprint and does not compress or carry a compressive load. This allows the rest of structure not in the footprint area the ability to carry the load, resulting in a very load-efficient structure. It is desired to minimize this load for the reason above and to allow the shear band to bend to overcome road obstacles. The approximate load distribution is such that approximately 95% of the load is carried by the shear band and the upper radial portion of the reinforcement layer, so that the lower portion of the reinforcement structure undergoing compression carries virtually zero of the load, and preferably less than 10%.

The tread portion may be a conventional tread as desired and may include grooves or a plurality of longitudinally oriented tread grooves forming essentially longitudinal tread ribs there between. Ribs may be further divided transversely or longitudinally to form a tread pattern adapted to the usage requirements of the particular vehicle application. Tread grooves may have any depth consistent with the intended use of the tire. The tire tread may include elements such as ribs, blocks, lugs, grooves, and sipes as desired to improve the performance of the tire in various conditions.

The shear band is preferably annular. The shear band is located radially inward of the tire tread. The shear band includes a first and second reinforced elastomer layer. In a first embodiment of a shear band, the shear band is comprised of two inextensible reinforcement layers arranged in parallel and separated by a shear matrix of elastomer. Each inextensible layer may be formed of parallel inextensible reinforcement cords, embedded in an elastomeric coating. The reinforcement cords may be steel, aramid, nylon, polyester or other inextensible structure. The shear band may further optionally include a third reinforced elastomer layer (not shown) located between the first and second reinforced elastomer layers.

It is additionally preferred that the outer lateral ends of the shear band be radiused in order to control the buckled shape of the sidewall and to reduce flexural stresses.

In the first reinforced elastomer layer, the reinforcement cords are oriented at an angle Φ in the range of 0 to about +/−10 degrees relative to the tire equatorial plane. In the second reinforced elastomer layer, the reinforcement cords are oriented at an angle φ in the range of 0 to about +/−10 degrees relative to the tire equatorial plane. Preferably, the angle Φ of the first layer is in the opposite direction of the angle φ of the reinforcement cords in the second layer. That is, an angle +Φ in the first reinforced elastomeric layer and an angle −φ in the second reinforced elastomeric layer.

The shear matrix may have a radial thickness in the range of about 0.10 inches to about 0.2 inches, more preferably about 0.15 inches. The shear matrix is preferably formed of an elastomer material having a shear modulus Gₘ in the range of 15 to 80 MPa, and more preferably in the range of 40 to 60 MPA.

The shear band has a shear stiffness GA. The shear stiffness GA may be determined by measuring the deflection on a representative test specimen taken from the shear band. The upper surface of the test specimen is subjected to a lateral force F as shown below. The test specimen is a representative sample taken from the shear matrix material, having the same radial thickness.

The shear stiffness GA is then calculated from the following equation:

GA=F*L/ΔX

The shear band has a bending stiffness EI. The bending stiffness EI may be determined from beam mechanics using the three-point bending test subjected to a test specimen representative of the shear band. It represents the case of a beam resting on two roller supports and subjected to a concentrated load applied in the middle of the beam. The bending stiffness EI is determined from the following equation: EI=PL³/48*ΔX, where P is the load, L is the beam length, and ΔX is the deflection.

It is desirable to maximize the bending stiffness of the shear band EI and minimize the shear band stiffness GA. The acceptable ratio of GA/EI would be between 0.01 and 20, with a preferred range between 0.01 and 5. EA is the extensible stiffness of the shear band, and it is determined experimentally by applying a tensile force and measuring the change in length. The ratio of the EA to EI of the shear band is acceptable in the range of 0.02 to 100, with a preferred range of 1 to 50. The shear band preferably can withstand a maximum shear strain in the range of 15-30%.

The shear band has a spring rate k that may be determined experimentally by exerting a downward force on a horizontal plate at the top of the shear band and measuring the amount of deflection. The spring rate k is determined from the slope of the Force versus deflection curve.

The non-pneumatic tire has an overall spring rate kₜ that is determined experimentally. The non-pneumatic tire is mounted upon a rim, and a load is applied to the center of the tire through the rim. The spring rate kₜ is determined from the slope of the Force versus deflection curve. The spring rate kₜ is preferably in the range of 500 to 0 for small low speed vehicles such as lawn mowers.

The invention is not limited to the shear band structure disclosed herein, and may comprise any structure which has a GA/EI in the range of 0.01 to 20, or a EA/EI ratio in the range of 0.02 to 100, or a spring rate kₜ in the range of 500 to 0, as well as any combinations thereof. More preferably, the shear band has a GA/EI ratio of 0.01 to 5, or an EA/EI ratio of 1 to 50 and any subcombinations thereof. The tire tread is preferably wrapped about the shear band and is preferably integrally molded to the shear band.

### Ply Reinforcement Spoke Structure

A first embodiment of the non-pneumatic wheel 210 of the present invention is shown in FIGS. 3A and 3B. The reinforcement structure functions to carry the load transmitted from the shear layer and also to form aerodynamic vanes for lift. The reinforcement structure comprises a plurality of vanes 220 that extend from the hub or inner radius 230 to the inner portion of the tread 250. Preferably, the vanes 220 are angled to provide the aerodynamic lift forces. More preferably, the vanes are angled over 180 degrees from the hub to the shearband. The aerodynamic vanes are primarily loaded in tension and shear and carry no load in compression. The aerodynamic vanes may comprise any fabric or flexible structure such as nylon, polyester, cotton, rubber. Preferably, the aerodynamic vanes comprise a reinforced rubber or ply layer formed of parallel reinforcements that are nylon, polyester, steel, metal or aramid. Preferably, the reinforcements are oriented in the radial direction. It is preferred that tire ply be used as a reinforcement layer for several reasons. First, tire ply is an ideal connecting structure for the non-pneumatic tire application because it is thin and has a low bending stiffness with no resistance to compression or buckling. Tire ply has a high tensile stiffness and strength which is needed in the non-pneumatic tire application. Tire ply is also cheap, has a known durability, and is readily available. Furthermore, a continuous ply reinforcement layer eliminates debris which can be caught into spoke or web non-pneumatic tire designs, and does not contribute to tire noise or high frequency harmonics associated with discrete spokes.

The non-pneumatic wheel is designed to support the weight of the vehicle for worry-free mobility on the road, while becoming vanes of a rotor for flight of the vehicle. The non-pneumatic tire is designed to be rotated 90 degrees for vertical takeoff and landing of the vehicle. As shown in FIG. 4, each vane has a light-based sensor for diagnostic integrity check. Light is diffused through the tire's material to sense the integrity of each vane. If the emitted light enters the receiver with a different intensity or homogeneity, a signal is sent to indicate that maintenance is needed. On the outer perimeter on each side of the wheel is located an annular ring of light 300, which can function as a turn signal, a brake light or as airplane safety strobe lights.

The nonpneumatic wheel also includes one or more cooling fins.

The tread structure of the nonpneumatic wheel is preferably porous, so that light from the light based sensor may also be used to sense the road or flight conditions.

Applicants understand that many other variations are apparent to one of ordinary skill in the art from a reading of the above specification. These variations and other variations are within the spirit and scope of the present invention as defined by the following appended claims.

What is claimed:

1. A flying machine comprising:
a light weight housing having a cabin for housing one or more passengers, a flight control system, and at least two nonpneumatic wheels, wherein each nonpneumatic wheel includes a ground contacting annular tread portion; a plurality of vanes extending between a hub of the nonpneumatic wheel and the annular tread, wherein each vane is formed of a reinforcement layer of fabric, wherein each nonpneumatic wheel is mounted on a rotatable support arm, and wherein the wheel is rotated at a high rate of speed to generate lift of the flying machine.

2. The flying machine of claim 1 wherein the flight control system is capable of autonomous operation.

3. The flying machine of claim 1 wherein the vanes of the non-pneumatic wheel are rotated 180 degrees from the inner hub to the outer radius of the vanes.

4. The flying machine of claim 1 wherein the nonpneumatic wheel includes a light emission sensor to sense the road conditions.

5. The flying machine of claim 1 wherein the nonpneumatic wheel includes a light emission sensor to diffuse light through the vanes to detect the system integrity.

6. The flying machine of claim 1 wherein the nonpneumatic wheel further includes an artificial intelligence unit which interprets the information it receives from the light sensor and communicates tire status information to nearby vehicles and to a control system of the flying machine.

7. The flying machine of claim 1 wherein the nonpneumatic wheel further includes a flexible photovoltaic sidewall for converting solar energy into electricity.
